(19) United States
(12) Patent Application Publication
(10) Pub. No.: US 2025/0289485 A1
(43) Pub. Date: Sep. 18, 2025

(54) CONTROL DEVICE, DRIVE TRAIN HAVING SUCH A CONTROL DEVICE, MOTOR VEHICLE HAVING SUCH A DRIVE TRAIN, AND METHOD FOR OPERATING SUCH A CONTROL DEVICE

(71) Applicant: Rolls-Royce Solutions GmbH, Friedrichshafen (DE)

(72) Inventors: Ingo Lehmann, Owingen (DE); Frederic Dumser, Hergensweiler (DE)

(73) Assignee: Rolls-Royce Solutions GmbH, Friedrichshafen (DE)

(21) Appl. No.: 19/221,824

(22) Filed: May 29, 2025

Related U.S. Application Data
(63) Continuation of application No. PCT/EP2023/083076, filed on Nov. 24, 2023.

(30) Foreign Application Priority Data
Dec. 1, 2022 (DE) 10 2022 131 920.2
Nov. 24, 2023 (WO) PCT/EP2023/083076

(51) Int. Cl. B61L 15/00

(52) U.S. Cl. CPC B61L 15/0081

(57) ABSTRACT

A control device includes: a first control module, which is configured for being operatively connected with a controlled device, the first control module being configured for: checking, in response to a safety signal, whether the controlled device is in a predetermined safety state; and taking at least one safety measure so as to bring the controlled device into the predetermined safety state if the checking shows that the controlled device is not in the predetermined safety state.

### CROSS REFERENCE TO RELATED APPLICATIONS

This is a continuation of PCT application no. PCT/EP2023/083076, entitled “CONTROL DEVICE, DRIVE TRAIN WITH A CONTROL DEVICE OF THIS TYPE, MOTOR VEHICLE WITH A DRIVE TRAIN OF THIS TYPE, AND METHOD FOR OPERATING A CONTROL DEVICE OF THIS TYPE”, filed Nov. 24, 2023, which is incorporated herein by reference. PCT application no. PCT/EP2023/083076 claims priority to German patent application no. 10 2022 131 920.2, filed Dec. 1, 2022, which is incorporated herein by reference.

### BACKGROUND OF THE INVENTION

### 1. Field of the Invention

The present invention drive trains.

### 2. Description of the Related Art

In safety relevant areas or environments, in particular with reference to drive technology and especially with regard to rail vehicle drives, situations arise in which—from a safety perspective—it must be ensured that certain controlled devices, for example a drive unit with a manual transmission are in certain safe states, for example in a neutral position. For example, in the case of a drive of a rail vehicle, it must be ensured that in the event of an emergency stop or even at a standstill, for example in a railway station, no torque is introduced into drive wheels, which could act against the applied brake and thus reduce its braking force or cause unintended jerking or even rolling of the rail vehicle. To eliminate such risks in all cases, an electrical power supply to a control module of the controlled device that is to be brought into the safe state is typically interrupted in response to a safety signal, whereby the control module and thus simultaneously the controlled device enters the safe state or predetermined safety state as intended if the power supply is interrupted. The disadvantage of this is, however, that the power supply is interrupted without preparation, so that no operating values or errors of the controlled device can be stored. This can therefore lead to errors, especially in the control module of the controlled device, but in particular also to incorrect system reaction of other components that are operatively connected with the controlled device in the integrated system, when the controlled device is switched on again. This, in turn, can have an impact on the life expectancy of both the controlled device and other components.

What is needed in the art is a control device, a drive train having such a control device, a motor vehicle having such a drive train and a method for operating such a control device, wherein the aforementioned disadvantages are at least reduced, optionally avoided.

### SUMMARY OF THE INVENTION

The method relates to a control device, a drive train having such a control device and a method for operating such a control device.

The present invention provides a control device which includes a first control module, wherein the first control module can be operatively connected—in particular, is operatively connected—with a controlled device, in particular a drive unit. The first control module is arranged to check in response to a safety signal, whether the controlled device is in a predetermined safety state and to take at least one safety measure in order to bring the controlled device into the predetermined safety state if the check reveals that the controlled device is not in the predetermined safety state. Receipt of the safety signal signals in particular the requirement that the controlled device must be in the predetermined safety state or must be moved into the latter. The check conducted by the first control module as to whether the controlled device is in the predetermined safety state, advantageously permits, in particular, omitting at least delaying further, stronger safety measures—such as in particular an interruption of the electrical power supply to a second control module of the controlled device or a shutdown of the controlled device—if the controlled device is already in the predetermined safety state because then the safety requirements have already been met even without such stronger measures. This advantageously enables the controlled device, in particular the second controlled device to store operating values and/or errors, so that a functional restart is possible after a potentially still occurring shutdown. This is beneficial not only for the life expectancy of the controlled device, but in particular also for the life expectancy of other components in the system network that are operatively connected with the controlled device.

The safety signal is in particular a signal that corresponds to a state of the control device in which the controlled device must be in the predetermined safety state or must be placed into the predetermined safety state.

In one embodiment, the first control module is arranged to receive the safety signal. The safety signal may, in particular be received from another sector or module of the control device, or from outside the control device. In one embodiment, the first control module has an interface which is designed to receive the safety signal; alternatively, or in addition, the control device has an interface which is designed to receive the safety signal. In another embodiment, the safety signal may be generated by the first control module itself, in particular in response to an internal state of the control device or another signal received from outside the control device. In one embodiment, the first control module and/or control device has an interface that is designed to receive the other signal from outside the control device.

In the context of the present technical teaching, a signal is generally understood to mean machine-readable information or evaluation that is accessible to machine evaluation, in particular automatically writable and readable, electrical or electronic information or representation of a situation, a message or a command. This can be an analog signal, in particular a current or voltage value, a digital signal, or an information-theoretical state, in particular a value of a variable, in particular of a binary variable, in particular a so-called flag, a bit or a bit sequence of bits, in particular the state of a certain bit, or another state implemented by hardware or software technology. A signal does thereby not have to be explicitly present but can also result implicitly from another hardware or software state. The transmission of a signal is also understood in particular to mean the writing of a relevant electrical or electronic representation. Receiving a signal is also understood in particular as reading a relevant electrical or electronic representation.

In the context of the present technical teaching, the expression “in response to a signal” means in particular “a reaction to a signal”.

In the context of the present technical teaching, a module is generally understood in particular as a mentally or physically defined or definable functional unit which is designed to perform at least one specific function. This can be a separate computing device, part of a computing device, a hardware structure, or a software structure that is arranged to, and intended to perform at least one specific function. In particular, the functionality of a module may be implemented into the control device by way of hardware and/or software. The module does not have to be a separate device or structure that can be physically or mentally separated.

A further development of the present invention provides that the first control module can be operatively connected, in particular, is operatively connected to the second control module of the controlled device. The first control module is arranged in particular to check whether the second control module is in the predetermined safety state.

A further development of the present invention provides that the first control module is arranged to detect at least one supply parameter of the electrical power supply of the controlled device and to check by way of the at least one supply parameter, whether the controlled device is in the predetermined safety state. It can thus advantageously easily and quickly be determined whether the controlled device is in the predetermined safety state. In particular, different values of the at least one supply parameter or combinations of values of different supply parameters can be explicitly assigned to different states of the controlled device, including the predetermined safety state, so that by determining the momentary value of the at least one supply parameter or of a momentary combination of values of different supply parameters the current state of the controlled device can be clearly determined, wherein in particular it can also be determined whether the controlled device is currently in the predetermined safety state.

The at least one supply parameter is selected in particular from a group consisting of voltage and current of the electrical power supply. These supply parameters characterize in particular the momentary power of the electrical power supply. It has been recognized that the power consumption of the controlled device differs significantly depending on its present state. Therefore, a momentary power consumption can be explicitly assigned to a momentary state of the controlled device. In particular, a momentary current of the electrical power supply can be explicitly assigned to a momentary state of the controlled device. In one embodiment, the at least one supply parameter is therefore in particular the current of the electrical power supply.

In one embodiment, the first control module includes a detection module designed to detect the at least one supply parameter. In one arrangement, the detection module may be a current measurement module that measures the current in a supply line for the electrical power supply of the controlled device, for example, by measuring a magnetic field surrounding the supply line.

In one embodiment, the control device, in particular the first control module, is designed to detect the at least one supply parameter by way of at least one hardware component, in particular a hardware circuit. The detection module is in particular a hardware component, in particular a hardware circuit. In one embodiment, the verification, based on the at least one supply parameter, to determine whether the controlled device is in the predetermined safety state is additionally performed using at least one hardware component, in particular a hardware circuit.

In one embodiment, a tabular assignment of values of the at least one supply parameter to states of the controlled device is stored in the control device, in particular in the first control module. As part of the check as to whether the controlled device is in the predetermined safety state, a momentary value of the at least one supply parameter is then captured in particular, the state of the controlled device assigned to the captured present value is looked up or read from the tabular assignment, and a check is performed to determine whether this represents the predetermined safety state. The tabular assignment can be determined, in particular, on a test bench.

A further development of the present invention provides that the first control module is designed to compare the at least one detected supply parameter with a predetermined threshold value and to determine, based on the comparison, whether the controlled device is in the predetermined safety state. This represents an especially simple form of assigning states of the controlled device to values of the at least one supply parameter, wherein, in particular, limits of states can be characterized by predetermined threshold values. In particular, the tabular assignment can include the predetermined threshold value or a plurality of predetermined threshold values.

In one embodiment the comparison of the at least one detected supply parameter with the predetermined threshold value occurs by way of at least one hardware component, in particular a hardware circuit. The predetermined threshold value is defined in particular by one or a number of jumpers, in particular by a status or position of the one or number of jumpers. In particular, the check based on the at least one supply parameter to determine whether the controlled device is in the predetermined safety state is additionally carried out by way of at least one hardware component, in particular a hardware circuit.

A further development of the present invention provides that the first control module is designed to detect the at least one supply parameter on the supply line for the electrical power supply of the controlled device. The detection of the supply parameter on the supply line is thereby especially direct and precise. In particular, the supply parameter can be measured directly in the supply line, or it can be tapped off the supply line, for example, in the case of current, by measuring a magnetic field around the supply line.

Alternatively, or in addition, the first control module is designed to interrupt the supply line or to de-energize it, in particular in order to switch off the controlled device. This makes it advantageously possible to bring the controlled device into the predetermined safety state, in particular by switching it off, if it is not already in the predetermined safety state. In this manner, a two-stage safety function is provided particularly advantageously, wherein in the first stage the check for the existence of the predetermined safety state takes place; wherein in the second stage —if the predetermined safety state is not present—the controlled device is brought into the predetermined safety state, almost forcibly, in particular by interrupting the supply line.

In one embodiment, the control module includes an interruption module which is designed to interrupt the electrical supply line. In one embodiment, the interruption module is designed as a hardware module or hardware component.

A further development of the present invention provides that the at least one safety measure is selected from a group consisting of: shutting down the controlled device, in particular shutting down the electrical power supply of the controlled device; shutting down the second control module, in particular shutting down an electrical power supply of the second control module; and a combination thereof. In this way, in particular, the controlled device can be brought—quasi forcibly—into the predetermined safety state.

The present invention also provides a drive train for a motor vehicle, which includes a drive unit and a control device according to the invention or a control device according to one or a number of the previously described embodiments, wherein the control device is operatively connected with the drive unit as the controlled device. In connection with the drive train, advantages arise in particular which were already previously described in connection with the control device.

A further development of the present invention provides that the drive unit includes a drive component and a second control module for controlling the drive component. In particular, the second control module is operatively connected with the drive component for the purpose of controlling it.

A further development of the present invention provides that the second control module and the drive component have a common electrical supply line, wherein the first control module is designed to interrupt the common electrical supply line or to de-energize it, in particular in order to switch off the drive unit as the controlled device. In particular, the second control module is optionally supplied with electrical power via the electrical supply line, whereby the second control module supplies the drive component with electrical power. As a result, the electrical supply line, or at least the electrical power for supplying the drive component, is quasi looped through the second control module.

A further development of the present invention provides that the drive component is designed to be hydraulically operated, wherein the drive unit also has at least one pressure generating device for generating hydraulic pressure for operating the drive component, wherein the second control module and the at least one pressure generating device have a common electrical supply line. In particular, as part of the second stage of the safety function described above, the pressure generating device is switched off together with the second control module, so that no pressure is available for operating the drive component. The drive component is designed in particular such that it enters the predetermined safety state without pressure. In particular, an increased hydraulic pressure is required to shift the drive component from the predetermined safety state to a different condition. The drive component returns automatically to the predetermined safety state in the event of a pressure drop, in particular due to mechanical preload.

A further development of the present invention provides that the drive component is designed as a transmission, in particular as a manual transmission, wherein the predetermined safety state corresponds to a neutral position of the drive component designed as a transmission. In this arrangement, the advantages already described are realized in a special way. In particular, the transmission can no longer transmit drive torque in the neutral position, so that, particularly in the event of emergency braking or a stop, no torque can be applied against an acting brake. Therefore, to meet safety requirements, it is generally sufficient if it can be ensured that the transmission is arranged in the neutral position without necessarily requiring an additional interruption of the electrical power supply. Only if the transmission does not shift into, or is not in the neutral position, for example due to a fault, can the electrical power supply also be advantageously interrupted by way of the previously described second stage, thus forcibly bringing the transmission into the neutral position. In particular, the transmission is designed such that it is shifted by way of hydraulic pressure, whereby it automatically returns to the neutral position and thus to the predetermined safety state without pressure, in particular due to mechanical preload. In particular, increased hydraulic pressure is required to shift the transmission from the predetermined safety state into another state, in particular to engage a gear.

In particular, the second control module is a transmission control module.

The present invention also provides a motor vehicle that includes a drive train according to the present invention or a drive train according to one or a number of the previously described embodiments. In connection with the motor vehicle, advantages arise in particular that were already previously explained in connection with the control device or the drive train.

A further development of the present invention provides that the motor vehicle is designed as a rail vehicle. In particular, this achieves in a special manner the advantages already described, particularly in connection with emergency braking or a stop, especially at a train station.

The motor vehicle is designed in particular as a locomotive, as a railcar, as a multiple unit train, or as a railcar train.

The present invention also provides a method for operating a control device, wherein, in response to a safety signal, a check is conducted to determine whether a controlled device that is operatively connected to the control device is in a predetermined safety state, and wherein at least one safety measure is taken to bring the controlled device into the predetermined safety state if the check reveals that the controlled device is not in the predetermined safety state. Advantages arise in connection with the method, in particular, advantages that were already explained previously in connection with the control device, the drive train, or the motor vehicle.

In particular, a control device according to the present invention or a control device according to one or according to a number of the previously described embodiments is operated within the scope of the method.

The method includes in particular, at least one process step, in particular a combination of process steps, which was or which were explained explicitly or implicitly in connection with the control device, the drive train or the motor vehicle.

A further development of the present invention provides that—as the at least one safety measure—the controlled device is shut down if the test shows that the controlled device is not in the predetermined safety state. Alternatively, or in addition, a second control module of the controlled device is switched off as the at least one safety measure.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 a schematic representation of one design example of a motor vehicle with a design example of a drive train and a design example of a control device; and

FIG. 2 a schematic representation of the operating principle of the control device according to FIG. 1.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

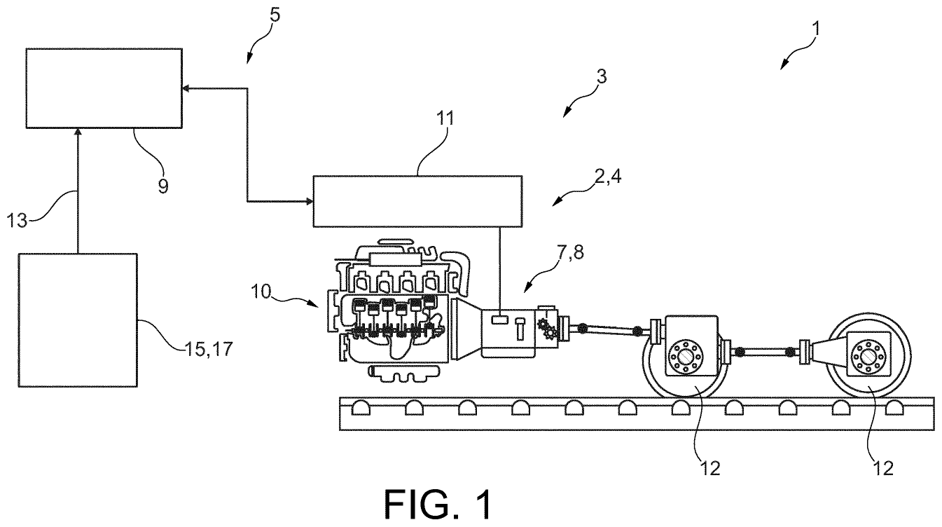

FIG. 1 is schematic representation of one design example of a motor vehicle 1 with a design example of drive train 3 and a design example of control device 5.

Motor vehicle 1 is designed, in particular, as a rail vehicle, in particular as a locomotive, railcar, multiple unit train or as a railcar train.

Drive train 3 includes control device 5 and, as a controlled device 2, in particular a drive unit 4. Drive unit 4 includes, in particular, a drive component 7 which is designed as a transmission 8, in particular as a manual transmission to which a neutral position is assigned as a predetermined safety state. In the neutral position, engine 10 of motor vehicle 1 is decoupled in particular from drive wheels 12 so that, in particular, in the event of an emergency braking or stop in a train station, no torque can be introduced by engine 10 via transmission 8 into drive wheels 12, which could counter a brake.

Moreover, drive unit 4 has a second control module 11 for controlling drive component 7, wherein second control module 11 in this case is designed in particular as a transmission control module for controlling transmission 8.

Control device 5 has a first control module 9 which is operatively connected with second control module 11.

First control module 9 is arranged to check in response to safety signal 13 whether controlled device 2 is in the predetermined safety sate—in this case in neutral position of transmission 8—and to take at least one safety measure to bring controlled device 2 into the predetermined safety state if the check discloses that controlled device 2 is not in the predetermined safety state. This advantageously makes it possible, in particular, to omit or at least delay an interruption of an electrical power supply for second control module 11 if controlled device 2 is already in the predetermined safety state, since the safety requirements are then met even without a shutdown. This, in turn, enables controlled device 2, in particular second control module 11, to restore operating values and/or errors, so that a functionally correct restart of controlled device 2, in particular of second control module 11, is possible after a potential shutdown that may still occur.

The at least one safety measure is selected, in particular, from a group consisting of: shutting down controlled device 2, in particular switching off an electrical power supply of controlled device 2; switching off second control module 11, in particular switching off an electrical power supply of second control module 11; and a combination thereof.

In the design example shown here, first control module 9 receives safety signal 13 in particular from a higher-level control device 15, in particular from a train control 17.

First control module 9 is designed, in particular, to detect at least one supply parameter, in particular one selected from voltage and current, of an electrical power supply of controlled device 2 and—based on the at least one supply parameter—to check whether controlled device 2 is in the predetermined safety state.

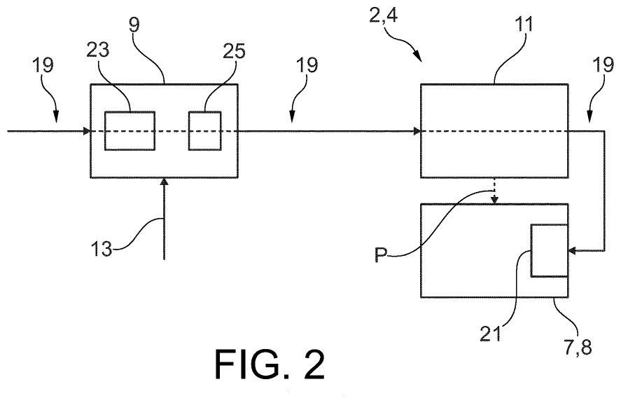

FIG. 2 shows a schematic presentation of the operating principle of control device 5 according to FIG. 1.

Identical and functionally identical elements are given the same reference signs in all drawings, so that a respective previous description can be referenced.

First control module 9 is arranged in particular, to detect the at least one supply parameter on an electrical supply line 19 for the electrical power supply of controlled device 2, in this case in particular of second control module 11. Alternatively, or in addition, first control module 9 is designed to interrupt supply line 19 or to de-energize it.

In particular, second control module 11 and drive component 7 feature electrical supply line 19 as a common electrical supply line 19. Second control module 11 is moreover designed to control drive component 7, as is schematically illustrated herein by a dashed arrow P.

Drive component 7 is designed in particular, to be operated hydraulically. Drive unit 4 has at least one pressure generating device 21 to generate hydraulic pressure for operation of drive component 7, in particular a hydraulic conveying device, in particular a pump. Second control module 11 and the at least one pressure-generating device 21 feature electrical supply line 19 as a common electrical supply line 19. Therefore, if first control module 9 interrupts supply line 19, pressure-generating device 21 is also switched off simultaneously with second control module 11 being switched off. As a result, the hydraulic pressure in drive component 7 drops. Due to a mechanical preload the latter then automatically moves into the neutral position, and thus into the predetermined safety state.

First control module 9 in particular has a detection module 23 which is designed to detect the at least one supply parameter. In one arrangement, detection module 23 can be a current measuring module that measures the current in supply line 19, for example, by measuring a magnetic field surrounding supply line 19.

Moreover, control module 9, optionally has an interruption module 25 which is designed to interrupt electrical supply line 19, thus in particular preventing the power supply to second control module 11 and pressure generating device 21.

In one arrangement, first control module 9 is arranged to compare the at least one detected supply parameter with a predetermined threshold value and to determine, based on the comparison, whether controlled device 2 is in the predetermined safety state.

Within the scope of a method for operating control device 5, a check is performed based on safety signal 13 as to whether controlled device 2 is in the predetermined safety state. At least one safety measure is taken to bring controlled device 2 into the predetermined safety state if the check shows that controlled device 2 is not in the predetermined safety state. Should this be the case, controlled device 2 is shut down in particular. Alternatively, or in addition, second control module 11 is shut down.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A control device, comprising:
a first control module, which is configured for being operatively connected with a controlled device, the first control module being configured for:
checking, in response to a safety signal, whether the controlled device is in a predetermined safety state; and
taking at least one safety measure so as to bring the controlled device into the predetermined safety state if the checking shows that the controlled device is not in the predetermined safety state.

2. The control device according to claim 1, wherein the first control module is configured for being operatively connected with a second control module of the controlled device.

3. The control device according to claim 2, wherein the first control module is configured for checking whether the second control module is in the predetermined safety state.

4. The control device according to claim 1, wherein the first control module is configured for detecting at least one supply parameter of an electrical power supply of the controlled device and for checking, based on the at least one supply parameter, whether the controlled device is in the predetermined safety state.

5. The control device according to claim 4, wherein the first control module is configured for comparing the at least one supply parameter—which is detected—with a predetermined threshold value and, based on the comparing, for determining whether the controlled device is in the predetermined safety state.

6. The control device according to claim 4, wherein the first control module is configured at least one of (a) for detecting the at least one supply parameter on a supply line for the electrical power supply of the controlled device and (b) for interrupting or de-energizing the supply line.

7. The control device according to claim 2, wherein the at least one safety measure is selected from a group consisting of: shutting down the controlled device; switching off the second control module; or a combination thereof.

8. The control device according to claim 2, wherein the at least one safety measure is selected from a group consisting of: shutting down the controlled device by switching off the electrical power supply of the controlled device; switching off the second control module by switching off an electrical power supply of the second control module; or a combination thereof.

9. A drive train for a motor vehicle, the drive train comprising:
a drive unit; and
a control device, which is operatively connected with the drive unit as a controlled device, the control device including:
a first control module, which is operatively connected with the controlled device, the first control module being configured for:
checking, in response to a safety signal, whether the controlled device is in a predetermined safety state; and
taking at least one safety measure so as to bring the controlled device into the predetermined safety state if the checking shows that the controlled device is not in the predetermined safety state.

10. The drive train according to claim 9, wherein the drive unit includes a drive component and second control module configured for controlling the drive component.

11. The drive train according to claim 10, wherein the second control module and the drive component have a common electrical supply line, wherein the first control module is configured for interrupting or de-energizing the common electrical supply line.

12. The drive train according to claim 11, wherein the drive component is configured for being hydraulically operated, wherein the drive unit includes at least one pressure generating device configured for generating hydraulic pressure for operating the drive component, wherein the second control module and the at least one pressure generating device have the common electrical supply line.

13. The drive train according to claim 11, wherein the drive component is formed as a transmission, wherein the predetermined safety state corresponds to a neutral position of the drive component. RRP0072.US 3

14. The drive train according to claim 9, wherein the drive train is part of a motor vehicle, which is a locomotive, a railcar, a multiple unit train, or a railcar train.

15. A method for operating a control device, the method comprising the steps of:
checking, in response to a safety signal, whether a controlled device that is operatively connected with the control device is in the predetermined safety state; and
taking at least one safety measure so as to bring the controlled device into the predetermined safety state if the checking shows that the controlled device is not in the predetermined safety state.

16. The method according to claim 15, wherein the control device includes a first control module, which is configured for being operatively connected with a controlled device, the first control module being configured for performing the steps of checking and taking.
